(19) United States
(12) Patent Application Publication
(10) Pub. No.: US 2026/0275810 A1
(43) Pub. Date: Sep. 17, 2026

(54) DOMESTIC HYDRAULIC STEPLADDER CHARACTERIZED BY INFINITELY VARIABLE HEIGHT FOR STEPS AND PLATFORM

(71) Applicant: HITACHI HIGH -TECH CORPO

(72) Inventor: VENUGOPALAN CHENICHERI VADAKKIL, Bangalore (IN)

(21) Appl. No.: 18/995,249

(22) PCT Filed: Jun. 20, 2024
(86) PCT No.: PCT/IB2024/056025

§ 371 Date: Jan. 16, 2025

(30) Foreign Application Priority Data
Jun. 20, 2024 (IN) 202441047507

(51) Int. Cl. E06C 1/22; E06C 7/16; E06C 7/18

(52) U.S. Cl. CPC E06C 1/22; E06C 7/16; E06C 7/182

(57) ABSTRACT

A domestic hydraulic stepladder comprising of table top type wide area platform for standing and working at different high levels from the floor and said platform being split in the middle into two halves each half being separately mounted on two multi stage telescopic hydraulic cylinders, all four mentioned telescopic cylinders carried on a common base and being connected through a 3-10 position hydraulic valve to a small conventional air pre-pressurised hydro-pneumatic accumulator accompanied with a mini air pump for air pre-pressure control, for manual climbing of the stepladder a person gets up on the platform when both halves are at the same level at the lowest point of the stepladder by placing one foot on each of the half portions of the platform, then operating the 3-position valve and by taking appropriate stance on the platform achieves the raising/standing still/lowering of the platform.

### FIELD OF THE INVENTION

The present invention is related to stepladders commonly used in household indoors for climbing by individuals to reach levels from which they can access and work at jobs up to ceiling level while standing on a platform provided.

The present invention falls under the category of a stepladder basically because the user does the actual climbing of the steps which is formed by one or 10 the other split halves of the platform which when not loaded being in a position to be raised automatically to a higher level and in relation to the other stationary loaded half platform and when the two halves of the platform are at same level and locked into position the user reaches any desired higher level and is able to comfortably stand with both the feet at the same level on a broad combined platform to carry out any task at the higher level.

### BACKGROUND AND PRIOR ART

Almost all stepladders now existing and available will have only one platform of sufficient length and breadth with no obstructions, at a fixed level where a person can comfortably stand with both legs at same level and position the body in any of the 4 directions to attend to any necessary task. for example a 3 feet stepladder will have the type of platform mentioned above only at the fixed level of 3 feet, similarly a 4 feet stepladder at 4 feet and so on, even though some type of stepladders instead of narrower steps they are provided with wider steps almost the same size as the platform provided (Patent US 2017/0328131 A1) and being misrepresented as additional platforms they do not function as platforms as explained earlier in the paragraph because these steps are necessarily staggered one over the other (to avoid the stepladder occupying large footprint).

So when a person stands on a lower broad step, the next higher broad step will cause obstruction and only the topmost step/platform will function as real platform as clearly mentioned above.

It can be further explained here that a good functional platform will have a large area on which the user can stand without any obstruction, it provides a greater degree of security and stability for the user while working above the ground, so there is less or little concern from falling from the stepladder and incurring injury, by being on the platform that more closely simulates working on the ground, where the risk of injury from falling is no more or less than what the user typically experiences in day-to-day activities on the ground.

So the problem we have with all existing and available stepladder is that they do not serve the purpose most of the time because people come in different heights and they need to do different tasks at different heights at different times requiring the platforms to be at different heights, because of this with all present existing stepladders the user is forced to dangerously stand on the “rungs” of these stepladders to carry out various tasks in 95% of the situations and also keeping in mind different age groups and people of different body types who might not only find it difficult but also take the chance of hurting themselves by raising their legs from 8 to 12 inches and climb the stepladders existing and available at present.

It has been known for a long time, the use of hydro-pneumatic accumulator where the hydraulic fluid is kept under pressure by means of compressed air acting on a membrane separating the hydraulic fluid from the compressed air portion and the pressured hydraulic fluid being used through a hydraulic valve for actuation of extendable and retractable “single” piston in a hydraulic cylinder.

The above mentioned arrangement has been incorporated in several patents connected with height adjustable Dentist chair/stools etc, as per list of patent examples given below:
U.S. Pat. No. 2,218,963 (1940), U.S. Pat. No. 3,147,946 (1964),
U.S. Pat. No. 3,339,873 (1967),
U.S. Pat. No. 3,711,054 (1973), U.S. Pat. No. 4,220,307 (1980),
U.S. Pat. No. 6,494,124 (2002).

In all the above the range of height adjustment is limited and only a “single” large size piston cylinder combination is used.

The main reason why the “multi stage hydraulic telescopic arrangement” has never been used along with hydro-pneumatic accumulator in similar applications mentioned earlier is due to the unavailability of any arrangement so far to ensure strictly progressive extension and retraction of different stages, especially in the case of smaller diameter pistons and cylinders.

There are some patents covering progressive extension and retraction in the case of large diameter telescopic cylinders (which are operated with hydraulic pumps supplying hydraulic fluid at very high pressure and volume) where complicated valve mechanisms (occupying large area inside the cylinders) have been incorporated, examples are U.S. Pat. No. 3,259,027 (1966), U.S. Pat. No. 5,584,645 (1996).

Therefore, based on the above there is a serious need for new type of stepladder.

### OBJECT OF THE INVENTION

The object of the present invention is to create a new advanced domestic stepladder which addresses and overcomes all the short comings and all the problems (explained earlier) faced by every domestic stepladder user.

Another object of the present invention is to create a domestic stepladder with a comfortable and functional platform satisfying all the requirements with a built in arrangement where the user decides the height of the steps while on the stepladder and decides at what level he or she would like to be on the comfortable and functional platform, to carry out a particular task at hand keeping both legs at same level.

Apart from the above another major advantage of the present invention is its 50% smaller foot print compared to all existing and available options of domestic stepladders allowing its use more affectively in restricted spaces.

Another advantage of the present invention is the safety factor as the centre of gravity of the user while climbing shifts only by a very small fraction when comparing with all existing domestic stepladders as the climbing is achieved by side stepping instead of forward stepping as in presently available stepladders.

Yet another object of the present invention is that it will be first one ever to use the above mentioned hydro-pneumatic accumulator arrangement for operating a set of multi stage piston cylinder combination popularly called as “multi stage telescopic hydraulic cylinder arrangement” albeit in this case having comparatively smaller diameters for pistons and cylinders, but having several stages.

Still another object of the present invention is that it incorporates for the first time a hydro-pneumatic accumulator explained earlier which works on the basis of low pressure and low volume hydraulics along with multi stage telescopic hydraulic arrangement using small piston and cylinder diameters and still ensure strict progressive extension and retraction by means of a unique sliding valve arrangement.

Yet another object of the present invention is that it uses the principle of “hydraulic lock” (as fluids are not compressible) of a piston in a cylinder when a load is applied on the piston at any stage and there is no possibility of the hydraulic fluid being added or removed from the enclosed chamber formed between the piston and cylinder.

Still another object of the present invention is to provide the above “hydraulic lock” is what supports the weight of the person climbing and standing on the platform of the stepladder in the present invention.

Yet another object of the present invention is that this “hydraulic lock” principle will come into effect in a multi stage telescopic hydraulic cylinder only if it is strictly ensured that the pressurised hydraulic fluid is supplied only to the largest cylinder first and its piston extends to the almost end of stroke position and only after this the hydraulic fluid should be supplied to the next smaller cylinder and this sequence should be carried forward to all the stages of the multi stage telescopic hydraulic cylinder, the above necessary requirement is effectively achieved by the unique sliding valve arrangement incorporated inside the seal assembly of the piston of different stages of the multi stage telescopic hydraulic cylinders in the present invention.

### SUMMARY

As used herein, references to the “present invention” or “invention” relate to exemplary embodiments and not necessarily to every embodiment encompassed by the appended claims.

A domestic stepladder comprising a wide area combined platform in the shape of a table top and the said platform is split in the middle into two halves and each half being separately mounted on one or preferably two multi stage telescopic hydraulic cylinders, and the said telescopic cylinders being connected to a hydro-pneumatic accumulator through the pressure oil pipeline fitted with the 3-position hydraulic valve and necessary hydraulic check valves.

The present invention falls under the category of a stepladder basically because the user does the actual climbing of the steps which is formed by one or the other split halves of the platform which when not loaded being in a position to be raised automatically to a higher level and in relation to the other stationary loaded half platform by means of the pair of multi stage telescopic hydraulic cylinders attached to it raising up and outwards due to hydraulic pressure inside because of the pressurised oil being supplied from the hydro-pneumatic accumulator through the pressure oil pipeline fitted with the 3-position hydraulic valve and check valves and all the above happening during the climbing stage.

and when the two halves of the platform are at same level and locked into position (by using the cut-off or neutral position of the 3-position hydraulic valve mentioned earlier) the user reaches any desired higher level and is able to comfortably stand with both the feet at the same level on a broad combined platform and with the feet in any direction and take up any task up to house ceiling level by working facing any of the four directions or 360 degrees.

On completion of the task all the person has to do is operate the foot lever provided to select the third position of the 3-position hydraulic valve, which will bring the person back to the low level starting position as all the hydraulic fluid in the 4 telescopic cylinders mentioned above will flow back into the hydropneumatic accumulator (under the pressure of the weight of user descending from a higher level to a lower level and this potential energy will be stored in the hydro-pneumatic accumulator in the form of re-compressed compressed air in the air chamber for later use) and before getting off the platform bring the foot lever back selecting the cut-off/neutral position of the 3-position hydraulic valve.

### BRIEF DESCRIPTION OF DRAWINGS

FIG. 1 is a perspective views of the stepladder No. 1 in different stages wherein FIG. 1a shows No. 1 before it is positioned for climbing with the pre-step No. 13 still inside base unit assembly No. 2 and FIG. 1b,1c,1d represent the initial stages of climbing showing the platform 20a and 20b at different stages at different height from the floor;

FIG. 2 is also perspective views of the stepladder No. 1 in different stages wherein FIGS. 2a,2b,2c,2d represents the final stages of climbing possible;

FIG. 3 is a graphic representation of an user being on the stepladder No. 1 at different levels from the floor level;

FIG. 4 is a larger perspective view of the stepladder No. 1 with its main parts clearly numbered;

FIG. 5 is a perspective exploded view showing various parts of stepladder;

FIG. 6 is a perspective view of the stepladder No. 1 in its highest position with one of the enclosures No. 25B sectioned to show clearly the pair of multi stage telescopic hydraulic cylinder No 15C & 15D inside;

FIG. 7 is a perspective view of stepladder No. 1 in its highest position with both enclosures No. 25A & 25B removed showing No. 15A,15B,15C & 15D;

FIG. 8 represents a sectional view of a single multi stage telescopic hydraulic cylinder No. 15 (15C) showing its 4 stages 15Ca, 15Cb, 15Cc,15Cd the seal assemblies 16A,16B,16C, sliding valves 16Aa, 16Ba and valve operating chains No. 17A, 17B attached to 16Aa and 16Ba;

FIG. 9 represents enlarged cut section view of the portion marked by the dash and dot circle in of FIG. 8, to show clearly the seal assemblies No. 16 and its various sub-parts 16Aa, 16Ba and valve operating chains No. 17A,17B;

FIG. 10 represents a cross sectional view of a close-up portion showing the details of seal assembly No. 16A with its sliding valve assembly No. 16Aa in closed condition allowing no hydraulic fluid to pass through it;

FIG. 11 represents a perspective view of FIG. 10;

FIG. 12 represents a cross sectional view of a close-up portion showing the details of seal assembly No. 16A with its sliding valve assembly No. 16Aa in open condition allowing hydraulic fluid to pass through it;

FIG. 13 represents a perspective view of FIG. 12;

FIG. 14 represents a perspective view of the two half platforms No. 20a and 20b shown separately along with separated parts of sliding bearing No. 21;

FIG. 15 represents the perspective view of the two half platforms No. 20a and 20b shown combined with the assembled together of sliding bearing No. 21;

FIG. 16 is a perspective view of enclosure No. 14 of base unit assembly;

FIG. 17 represents a perspective view of base unit assembly No. 2 with its enclosing cover removed showing the internal parts;

FIG. 18 represents a perspective view showing the bottom portion of the stepladder No. 1 when it is at its maximum height giving a clear view of the 3-position valve No. 8 and the mounting bases for the four multistage telescopic hydraulic cylinders and the four supporting legs No. 10 of the base plate No. 3;

FIG. 19 represents a perspective view same as shown in FIG. 18 but with the four retractable swivel wheel assemblies inside the four supporting legs No. 10 now projecting out of these and being in their normal working position for moving the stepladder on the floor of the house due to the pre-step No. 13 being pushed back into its normal location inside base unit assembly No. 2 when the stepladder No. 1 is not being used for climbing etc;

FIG. 20 represents a schematic diagram using standard symbols to show some of the various parts and their connections in the stepladder No. 1;

FIG. 21 represents perspective view of another possible embodiment of the stepladder using only one multi stage hydraulic telescopic cylinder to support each of the two split platform and using a pair of base mounted platform guiding cum supporting handrail arrangement for the stepladder.

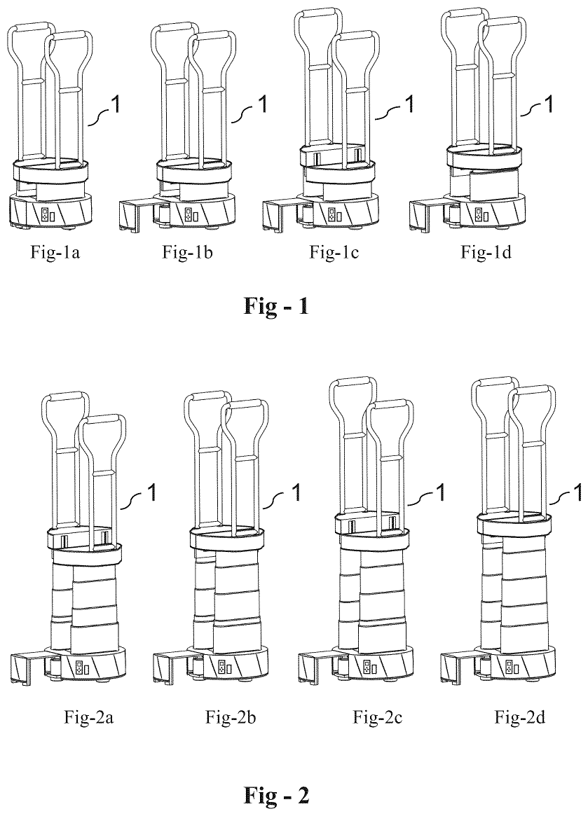

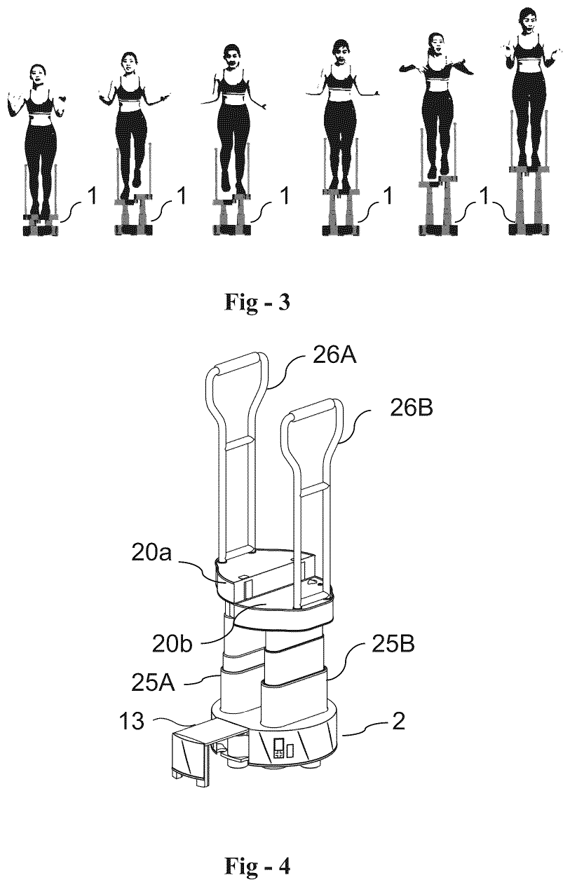

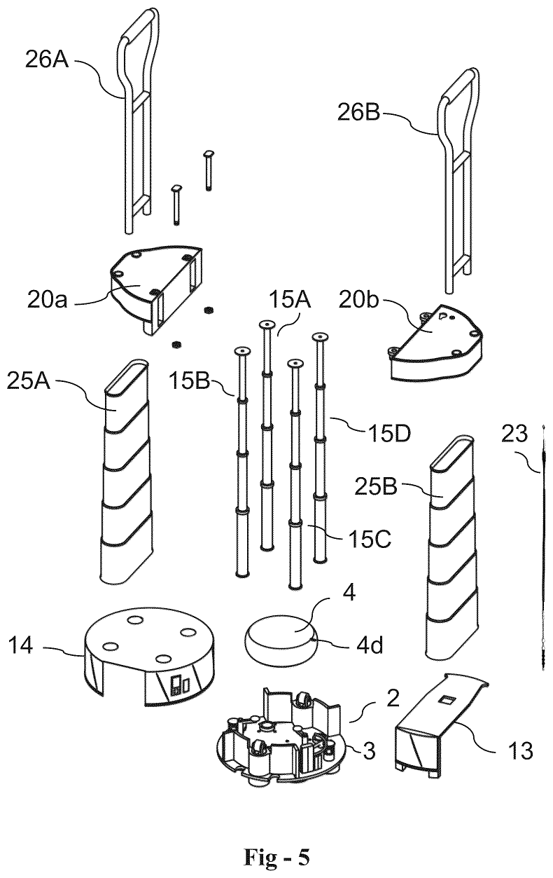

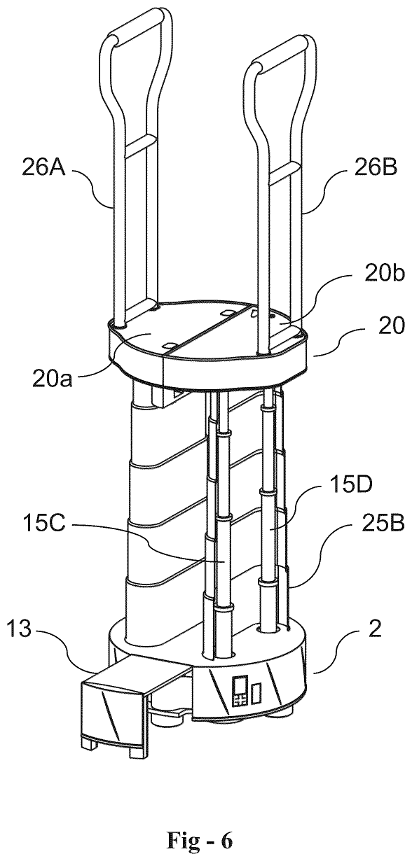

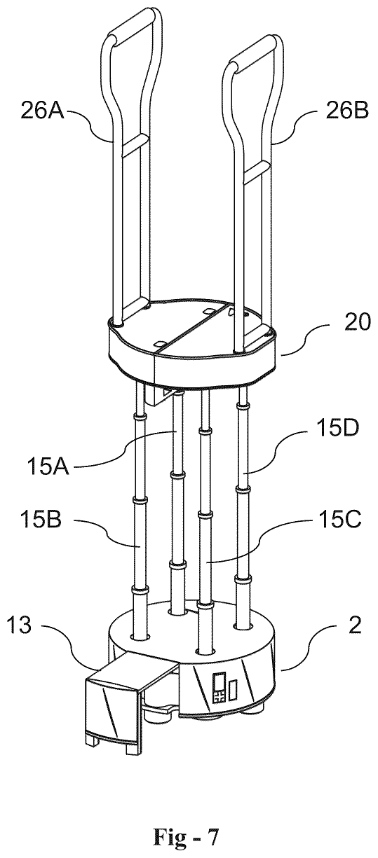

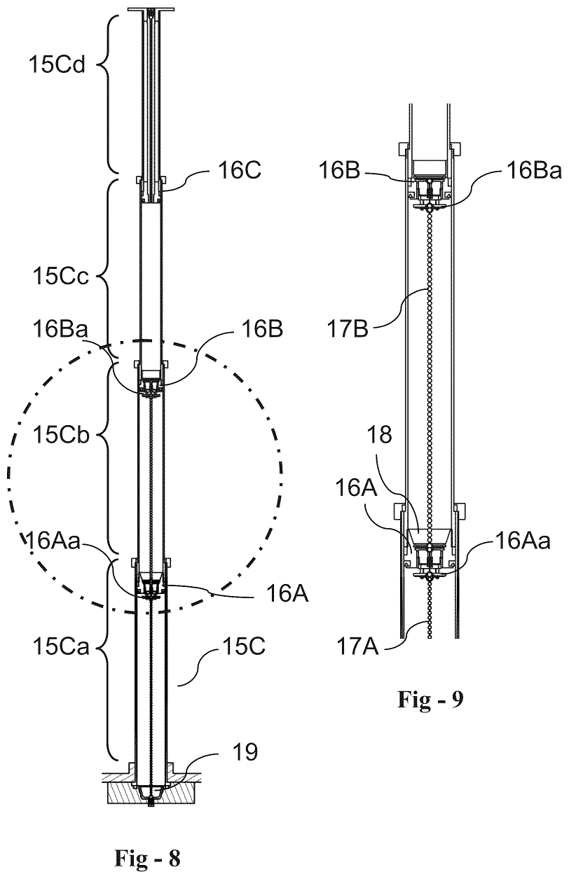

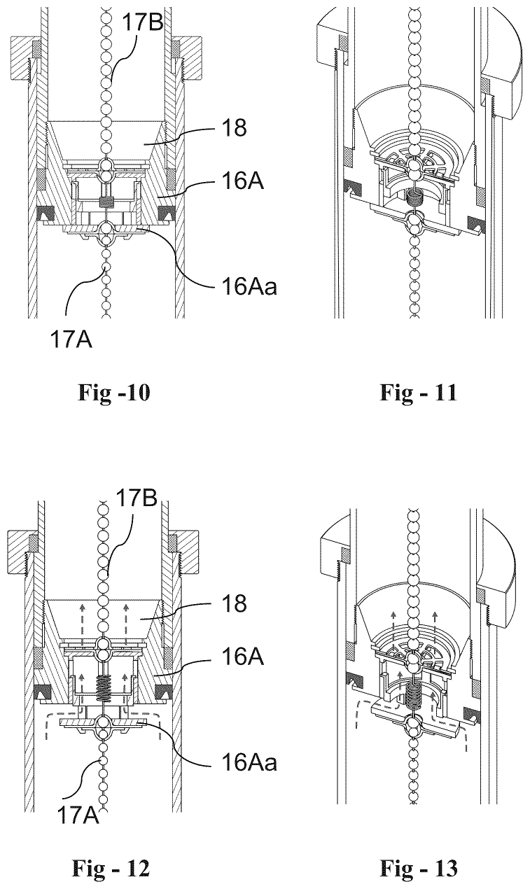

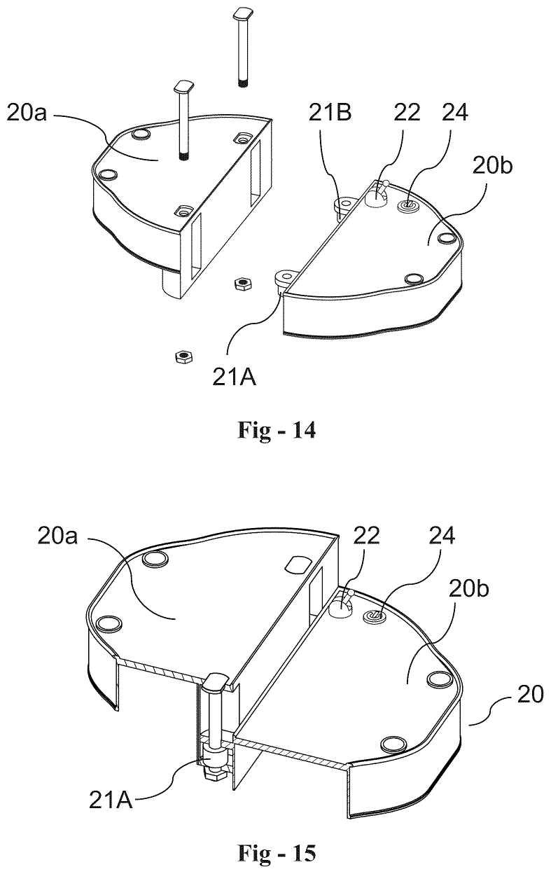

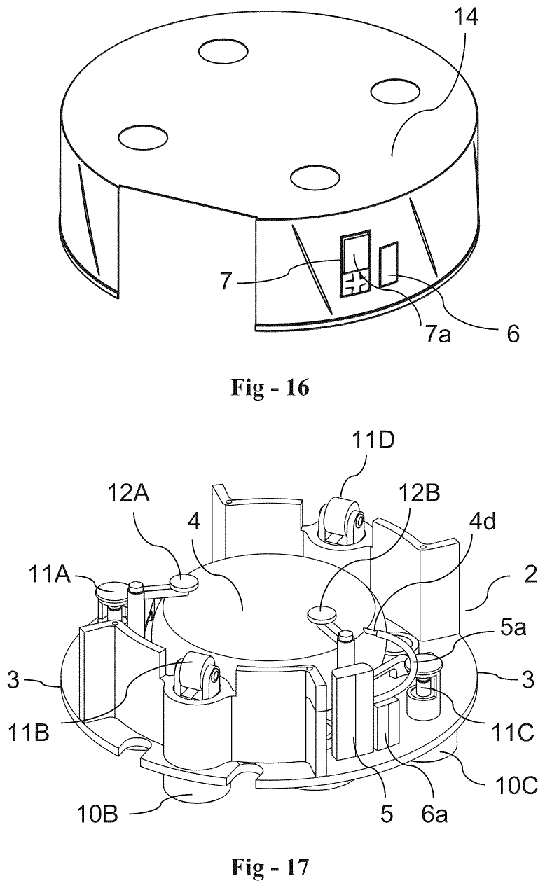

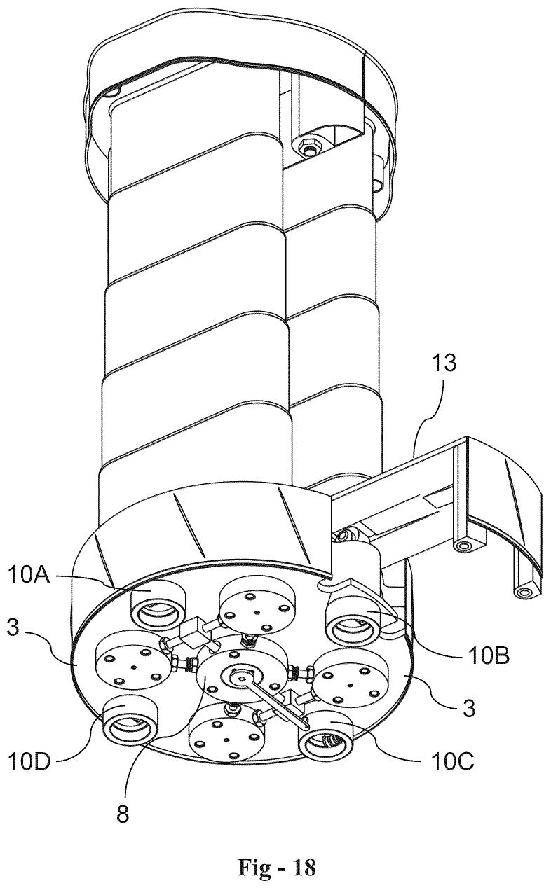

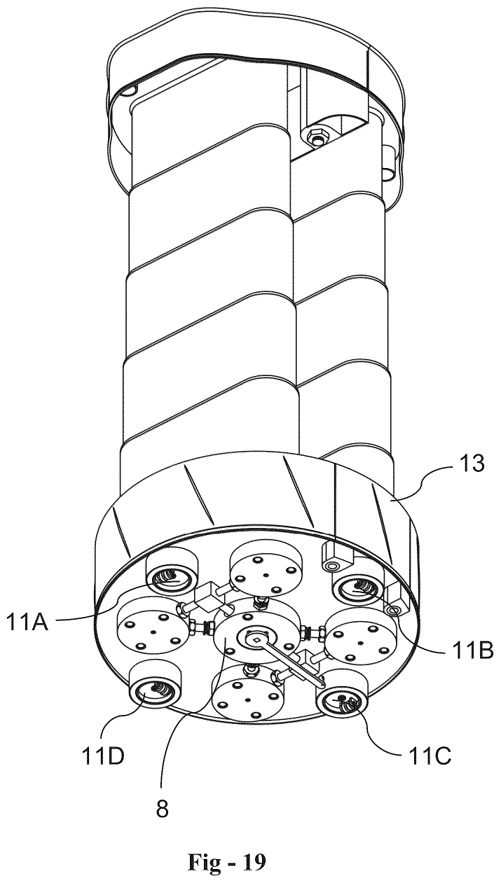

### LIST OF PART NAMES WITH NUMBERS

No. 1—Complete Hydraulic Stepladder.
No. 2—Base unit assembly.
No. 3—Base plate.
No. 4—Hydro-pneumatic Accumulator.
No. 4a—Hydraulic fluid chamber of Accumulator.
No. 4b—Air chamber of Accumulator.
No. 4c—Flexible membrane of Accumulator.
No. 4d—Air valve of Accumulator.
No. 4e—Hydraulic fluid Passage to & from No. 4a of Accumulator No. 4.
No. 5—Rechargeable battery operated mini air pump.
No. 5a—Compressed air pipeline connecting No. 5 to No. 4 & No. 7
No. 6—Battery compartment.
No. 6a—Rechargeable Battery.
No. 7—Mini Air-Pump operating cum display panel.
No. 7a—Pressure display on No. 7.
No. 8—3-Position hydraulic valve.
No. 9—One-way check valves in pipeline—4 Nos—(9A, 9B, 9C, 9D).
No. 10—Supporting Legs under the Base plate—4 Nos—(10A,10B,10C,10D).
No. 11—Retractable swivel caster wheel assemblies—4 nos—(11A,11B,11C,11D).
No. 12—Levers operating Retractable wheel assemblies—2 Nos—(12A, 12B).
No. 13—Built in Pre-step (inside No. 2) having pull-out and push in facility (resulting in the operation of Levers No. 12A & 12B and 11B & 11D).
No. 14—Enclosure for the Base Assembly (No. 2).
No. 15—Multi Stage Telescopic Hydraulic Cylinders—4 Nos—(15A,15B,15C,15D).
No. 15C—Telescopic Hydraulic Cylinder-Stages—Nos 4—15Ca,15Cb,15Cc,15Cd.
No. 16—Seal Assemblies—.on the pistons of each stage of the hydraulic telescopic cylinder—No. 15C—3 Nos (similar not same)—16A, 16B, 16C. 10 Spring operated Sliding Valve (Inside Seal Assembly No. 16A & 16B). 2 Nos—No. 16Aa, 16Ba.
No. 17—Valve operating chains for Sliding Valves—No. 16Aa & 16Ba-17A, 17B.
No. 18—Collapsed Chain 17B accommodating Bucket chamber on the seal assembly No. 16A.
No. 19—Collapsed Chain 17A accommodating Bucket chamber at the Bottom of stage 15Ca.
No. 20—Combined Platform . . . when Both halves of the platform are at same level.
No. 20a—Left-split half of the split but Combined Platform.
No. 20b—Right-split half of the split but combined Platform.
No. 21—Sliding Bearings connecting the two halves of Platform—2 Nos—21A, 21B.
No. 22—Foot lever on 20b for operating 3-position hydraulic valve No. 8.
No. 23—Cable & Sleeve mechanism for operating 3-Position valve No. 8 in base unit No. 2 using lever No. 22 on the half platform No. 20b.
No. 24—Switch for releasing Air Pressure in Air chamber 4b of No. 4.
No. 25—Enclosure (telescopic) for each pair of Multi Stage Telescopic hydraulic cylinders (15A & 15B) and (15C & 15D)—2 Nos—25A, 25B.
No. 26—Supporting Hand rails 2 Nos—26A, 26B.

### DETAILED DESCRIPTION

A hydraulic stepladder No. 1 comprising a wide area combined platform in the shape of a table top and the said platform is split in the middle into two halves, and each half when at different levels function as the steps of the stepladder and when they are at same level function as the combined platform No. 20 of the said stepladder, this being achieved by each half platform No. 20a & 20b being separately mounted on one or preferably two (as in the embodiment described here) multi stage telescopic hydraulic cylinders No. 15.

All the four said telescopic hydraulic cylinders 15A,15B,15C,15D, being connected to a hydro-pneumatic accumulator No. 4 having 2 flexible chambers, one for hydraulic fluid No. 4a and the other for compressed air No. 4b separated by means of a flexible membrane No. 4c so that the compressed air can pressurise the hydraulic fluid and vice versa.

A provision of a rechargeable battery operated mini air pump No. 5 (a mini version of the widely available rechargeable battery operated air pump used for inflating car and bike tyres) along with its operating cum display panel No. 7 and a battery compartment No. 6 for accommodating battery No. 6a, to increase or decrease the compressed air pressure in the air chamber No. 4b of earlier mentioned hydro-pneumatic accumulator No. 4 as and when required.

The hydraulic pressurised fluid connection between the mentioned hydropneumatic accumulator and the four multi stage telescopic hydraulic cylinders 15A, 15B, 15C, 15D passing through a 3-position hydraulic valve No. 8.

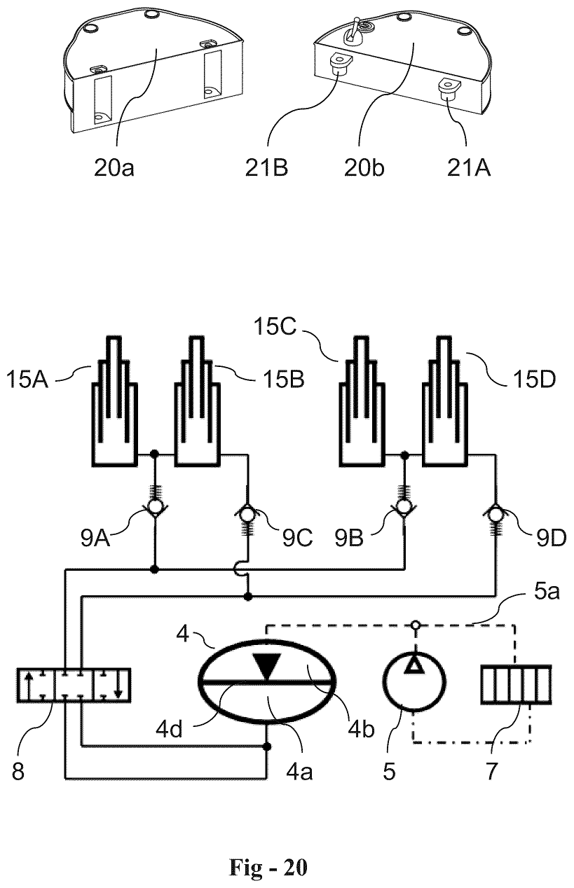

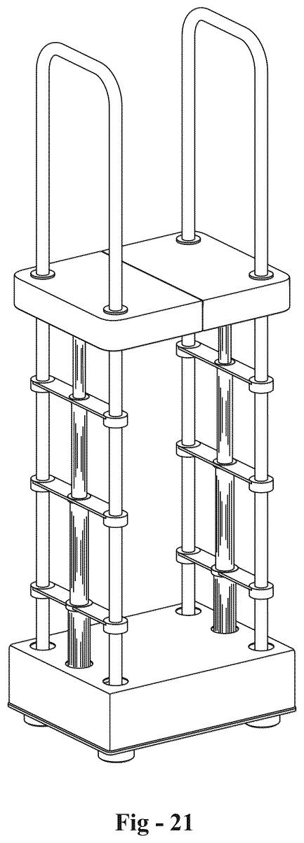

First position of the said 3-position hydraulic valve No. 8 is for the pressurised hydraulic fluid to flow from the hydro-pneumatic accumulator No. 4 to each of the above mentioned four multi stage telescopic hydraulic cylinders arranged as two pairs of multi stage telescopic hydraulic cylinders and the fluid circuit leading to each pair provided with individual one-way check valves No. 9A & 9B (refer also to the schematic drawing FIG. 20 attached).

Second position of the 3-position hydraulic valve No. 8 will be the standby and cut-off position to cut-off the flow in both directions.

The third position of the 3-position hydraulic valve No. 8 is for the hydraulic fluid from the above mentioned two pairs of multi stage telescopic hydraulic cylinders to return to the hydro-pneumatic accumulator through a circuit by-passing the above mentioned check valves No. 9A & 9B, but this circuit has been provided with two different check valves 9C & 9D to avoid cross flow between the two pairs of the multi stage telescopic hydraulic cylinders.

For climbing the stepladder to do a particular task at a higher level from the floor of the house at a particular location, a person will first roll the stepladder which will be normally be resting on its four spring loaded retractable swivel caster wheels No. 11 to that particular location and pull out the pre-step No. 13 with his or her leg which will result in (operation of levers No. 12) the four spring loaded retractable swivel caster wheels No. 11 being retracted inside four supporting legs No. 10 under the base plate No. 3 and now resting the stepladder firmly and directly on the floor; preventing the stepladder from the possibility of lateral movement while the user climbing up and down or standing on it at a higher level from the ground and carrying out any task at that level.

Once the stepladder is properly positioned as explained earlier he or she will get on to the combined platform No. 20 (formed by both half platforms No. 20a & No. 20b being at same lowest level from the floor) by making use of the pre-step No. 13 and by placing one foot on each of the half platforms No. 20a & 20b, then operating the foot lever No. 22 provided on 20b, which in turn will operate the 3-Position hydraulic valve No. 8 mentioned above from the standby cut-off position to the first position, then when the person rises one leg and releases the load on one half of the platform No. 20, that half of the platform will start rising up slowly till the foot load is transferred back on it (how soon or how slowly the user applies the foot load results in infinitely variable height for steps and platform No. 20) or it reaches the pre-set limit of 4 inches and will get locked in that higher position due to the principle of “hydraulic lock” caused due to the one way check valve arrangement provided, the “hydraulic lock ”principle is already explained earlier in detail in the paragraph—0019.

Then the person rises himself/herself by transferring his/her weight to higher positioned half of the platform by raising his/her other leg and releasing load from the other half of the platform which will now start raising and come in level with the first mentioned half of the platform and when load is applied on it lock itself it that position, this process can be repeated till both half of the platform is at level position at the required height and then by operating the foot lever the second position of the 3-Position valve can be selected which will be the cut-off or neutral position, after this both legs can be placed anywhere on the combined platform to take up a comfortable stance and carry out any task up to house ceiling level facing any of the four directions and all of 360 degrees.

On completion of the task all the person has to do is operate and bring the foot lever No. 22 to its third position which in turn will select the third position of the 3-position hydraulic valve situated in the base assembly No. 2 at the underside of the base plate No. 3, which will bring the person back to the low level starting position as all the hydraulic fluid in the four multi stage telescopic hydraulic cylinders mentioned above will flow back into the hydro-pneumatic accumulator (under the pressure of the weight of user descending from a higher level to a lower level and this potential energy will be stored in the hydropneumatic accumulator in the form of re-compressed compressed air in the air chamber for later use) and before getting off the platform bring the foot lever No. 22 back to the starting position selecting the cut-off/neutral position of the 3-position hydraulic valve No. 8.

Invention falls under the category of a stepladder basically because the user does the actual climbing of the steps which is formed by one or the other split halves of the platform which when not loaded being in a position to be raised automatically to a higher level related to the other stationary loaded half platform by means of the pair of multi stage telescopic hydraulic cylinders attached to it raising up due to hydraulic pressure inside due to pressurised hydraulic fluid being supplied from the hydro-pneumatic accumulator through the pressure pipeline fitted with the 3-position hydraulic valve and necessary check valves and all the above happening during the climbing stage.

When the two halves of the platform are at same level and locked into position (by using the cut-off or neutral position of the 3-position hydraulic valve already explained earlier) the user reaches any desired higher level and is able to comfortably stand with both the feet at the same level on a broad combined platform.

In this situation the user feels as if standing on a flat ground and with the feet in any direction and carry out any task facing any of the four directions or 360 degrees, climbing down procedure has already been explained.

Main parts of the present invention are:

Base unit assembly—No. 2 comprising a base plate No. 3 for mounting two pairs of multi stage telescopic hydraulic cylinders No. 15, one small capacity hydro-pneumatic accumulator No. 4, one 3- position hydraulic valve No. 8, hydraulic fluid pipelines connecting all the above through appropriately positioned check-valves No. 9, The base plate No. 3 at its bottom side having 4 supporting legs No. 10 (10A,10B,10C,10D) with anti skid footing for resting on the floor while the step ladder is used for climbing etc, apart from the mentioned 4 supporting legs the base plate has also provision of four spring loaded retractable swivel caster wheel assemblies No. 11 arrangement (built inside the above mentioned legs) for raising and supporting only the weight of the complete assembly of the invention for easily moving it around on the floor of the house.

The base unit assembly No. 2 also has a built in pre-step No. 13 arrangement for any user to conveniently get on the combined platform No. 20 of the stepladder in its lowest position while starting to climb the stepladder.

After the user rolls the stepladder and sets it at the required location for climbing to carry out any task at a higher level from the floor level, the user first pulls out into position the pre-step No. 13 provided using his or her leg.

The above mentioned action of the user results in retraction of the retractable swivel caster wheel assemblies No. 11 and the stepladder to be resting directly and firmly on the floor with no lateral movement possible for the step ladder while the user is climbing and working on the stepladder.

The pre-step when pulled out will also trigger a limit switch sending a signal to the mini air-pump operating cum display panel No. 7 to ensure the air pressure in the air chamber No. 4b of the hydro-pneumatic accumulator No. 4, has the pre-set pressure by controlling the operation of the mini air pump No. 5 as required.

After the use of the stepladder is completed, the user pushes the pre-step No. 13 back to its original position inside the base unit assembly No. 2 by use of his or her leg and this in turn will bring the retractable swivel caster wheel arrangement Nos. 11A,11B,11C,11D, to its original working position for rolling and moving the stepladder comfortably on the floor to anywhere in the house.

The base unit assembly No. 2 also includes an already mentioned rechargeable battery operated mini air pump No. 5 (a mini version of the widely available rechargeable battery operated air pump used for inflating car and bike tyres) connected to the compressed air chamber No. 4b of the above mentioned hydro-pneumatic accumulator No. 4, No. 5 mentioned above is provided with a operating cum display panel No. 7 and also with a mountable cum removable and rechargeable battery set-up consisting of a battery compartment No. 6 for accommodating rechargeable battery No. 6a for operating the air pump if and when required.

### Multi Stage Telescopic Hydraulic Cylinder Arrangement—No. 15.

Two pairs of multi stage telescopic hydraulic cylinders, one pair No. 15A & No. 15B and another pair No. 15C & No. 15D projecting outwards and upwards from the base unit assembly No. 2 and each pair enclosed in their individual telescopic enclosure No. 25A to enclose No. 15A & 15B and enclosure No. 25B to enclose No. 15C & 15D, one pair of the mentioned multi stage telescopic hydraulic cylinders, No. 15A & No. 15B being mounted with split half No. 20a of combined platform No. 20 and the other pair No. 15C & 15D being mounted on other split half No. 20b of the combined platform No. 20.

Multi stage hydraulic telescopic cylinders—No. 15: stages and details of only one multi stage telescopic hydraulic cylinder No. 15C is explained below.

In any telescopic hydraulic cylinder with multiple stages, the first stage is the largest of the cylinders and the piston of this stage after reaching its maximum stroke of forward movement, will act as the cylinder of the next stage and this applies to all the stages in continuing sequence till the last stage. In the present invention even though the cylinder sizes/diameters are comparatively small, The above mentioned sequence of operation will apply in its working.

Present invention ensures the that the hydraulic fluid is supplied only to the piston of the largest cylinder first and it extends to its almost end of stroke position and only after this the hydraulic fluid will be supplied to the next smaller cylinder and this sequence will be carried forward to all the stages, all this being achieved by the working of the incorporated sliding valves arrangement in the present invention.

The sliding valve arrangement consists of a sliding valves No. 16Aa and 16Ab (incorporated inside the seal assembly which forms the bottom part of each piston of the multi stage telescopic hydraulic cylinder No. 15C and the valve functioning as a normal one way spring operated hydraulic check valve with override function facility) which will be normally be kept in closed position by means of a spring, sliding valve of a particular piston of a particular stage is brought into open position after it has reached the almost end of its stroke.

The automatic opening of the sliding valve and allowing the hydraulic fluid to enter the next stage happens by means of the provision of a fixed length chain arrangement attached to the mentioned sliding valve and the top portion of sealing assembly of the preceding stage cylinder in the case of the second stage No. 15Cb and to the bottom of the cylinder in the case of second stage No. 15Ca of the multi stage telescopic hydraulic cylinder No. 15C, the fixed chain length will be a few millimetres shorter than the maximum stroke of the piston mentioned above, so the now stretched chain will in effect pull and open the sliding valve by counteracting with the spring pressure used to keep the valve normally closed.

Here it can be explained that the seal assembly/sealing assembly No. 16A at the bottom of the first stage piston and the bottom mounting of the first stage cylinders of the present invention is provided with a “bucket” chambers No. 18 & No. 19.

The above mentioned “bucket” chambers are of sufficient volume for safely accommodating the collapsed chain (the chain will collapse into a heap but still maintain the connection mentioned earlier) when the piston of each stage is at its withdrawn bottom position in the respective cylinders.

The split table top platform arrangement with combined platform No. 20.

As already explained earlier the “platform” is the important and critical portion of a stepladder ensuring the comfort and safety of while standing and working on a stepladder, domestic household tasks at various occasions and circumstances and to be carried out by persons of different heights will require the platform to be at infinite levels from the floor.

In the present invention having the split table top platform arrangement each of the two half platforms, performs as a step of the stepladder for the user to climb to a higher level as each half has the facility to rise slowly and automatically by the provided hydraulic arrangement when not loaded so when the user standing with one foot on each of the half platforms, raises his/her one foot off from say the first half platform No. 20a it will start raising slowly till the user steps on it and applies some load or it reaches the limit of 4 inches maximum height set for steps of the stepladder, it locks at that level due to “hydraulic lock” principle, when the user rises himself by transferring all his weight to the now raised first half platform No. 20a and once the other half No. 20b is unloaded it starts rising till it comes in level with the first raised half platform and locks in place resulting in both the halves of the platform being in same level, resulting in a (combined 2 half platforms) full broad platform so the 5 user decides the height increments of the platform by deciding on the heights of the steps the user is most comfortable with, the user repeats this procedure to achieve the combined platform height he or she desires.

The second split half of the platform No. 20b described above will be the one to have the appropriate location for the foot operated lever No. 22 for the appropriate positioning of the 3-position valve situated inside the base unit assembly No. 2, 20b also carries a switch for controlling air pressure in the air chamber No. 4b of the hydro-pneumatic accumulator No. 4 if and when required.

The two split halves of the platform, No. 20a and 20b are interconnected with a sliding bearing No. 21A & 21B arrangement to increase stability by preventing any possible lateral movement between the two halves as they raise or lower in relation with each other, (refer to the drawings attached).

### Hydro-Pneumatic Accumulator—No. 4.

The Invention incorporates a small capacity (example—3 to 4 litre capacity) hydro-pneumatic accumulator preferably having 50% of volume for hydraulic fluid chamber and the rest 50% volume for compressed air, The oil chamber is connected by hydraulic pressure pipe lines to the 4 multi stage telescopic hydraulic cylinders No. 15A,15B,15C,15D through a 3-position hydraulic valve No. 8 and several hydraulic check valves No. 9 positioned in the mentioned pipelines.

The compressed air chamber No. 4b of the hydro-pneumatic accumulator No. 4 is connected to a mini air pump No. 5 (explained in detail in description) with its operating cum display panel No. 7 which has provision to control the compressed air pressure in the compressed air chamber No. 4b of the hydropneumatic accumulator No. 4 as and when required for proper functioning of the Invention (refer also to the schematic drawing FIG. 20 attached).

### Seal Assemblies—No. 16: Three Numbers-Similar But Not Same

Each hydraulic piston in each of the cylinders together forming different stages of 4 multi stage telescopic hydraulic cylinders incorporated in the present invention will carry on the bottom a seal assembly consisting of piston guide and piston seals as appropriate, the seal assembly will also carry in its middle a “sliding valve assembly” (explained in detail in the drawings) and at the top it is provided with a “bucket” chamber for locating the collapsed valve operating chain when the pistons are at bottom of their stroke in their cylinders, these can be more clearly understood by drawings and their descriptions attached.

### 3—Position Hydraulic Valve—No. 8.

3-Position hydraulic valve No. 8 is provided in the hydraulic circuit between the hydro-pneumatic accumulator No. 4 and the 4 multi stage telescopic hydraulic cylinders No. 15A, 15B, 15C and 15D.

Multi stage telescopic hydraulic cylinders No. 15A, 15B, 15C and 15D arranged in pairs, one pair is made up of 15A & 15B, the other pair is 15C & 15D, first position of the 3-Position hydraulic valve No. 8 is for the pressurised hydraulic fluid to flow from the hydro-pneumatic accumulator through a one-way check valves No. 9A and 9B (these two valves will not allow reverse flow and are the ones contributing to the “hydraulic lock” arrangement which supports the weight of the person climbing and standing on the platform of the stepladder in the present invention-explained in detail in paragraph No. 0019) into each of the above mentioned pairs, second position which will be the standby and neutral position to cut-off the supply and the third position for hydraulic fluid from the above mentioned 4 telescopic hydraulic cylinders to return to the hydropneumatic accumulator through a route bypassing the above mentioned check valves No. 9A & 9B, but this circuit has been provided with two different check valves 9C & 9D to avoid cross flow between the two pairs of the multi stage telescopic hydraulic cylinders (refer schematic diagram FIG. 20 attached).

The three positions of the 3-position hydraulic valve No. 8 situated inside the base unit assembly No. 2 can be selected by a foot operated lever No. 22 mechanism provided at the appropriate location on the second split half of the platform No. 20b and it being connected to the 3-position hydraulic valve No. 8 situated inside the base unit assembly No. 2 by means of a flexible cable & sleeve mechanism arrangement No. 23 (similar to a commonly used bike clutch cable).

The operation of selecting the three different positions of the 3-position hydraulic valve No. 8 situated inside the base assembly No. 2 and the underside of base plate No. 3, is carried out by selecting the three different position of the foot lever No. 22 provided on right split platform No. 20b, wherein the foot lever 22 is linked to No. 8 by means of a flexible cable and sleeve mechanism No. 23 provided (this has not been clearly shown in the drawings submitted).

In a preferred embodiment, a domestic hydraulic stepladder characterized by infinitely variable height for steps and platform comprising the following: a wide area combined platform split into two half platforms, wherein the said half platforms at different levels function as the steps of the stepladder and wherein the said half platforms at same level function as the combined platform of the stepladder; one or more multi stage telescopic hydraulic cylinders connected to said half platforms, wherein the multi stage telescopic hydraulic cylinders enables to raise the unloaded half platform to a higher level relative to the other loaded half platform, a base unit assembly comprising of a base plate having 4 legs for resting on a floor; wherein the multi stage telescopic hydraulic cylinders mounted on the base unit assembly, wherein the each half platform being mounted on the multi stage telescopic hydraulic cylinders.

In an embodiment, each of the pairs carrying the half platform, wherein the combined platform having facility for each of the half platform to move independently in relation to the other half platform, wherein the half platforms connected to each other by means of a pair of sliding bearings.

In an embodiment, the multi stage telescopic hydraulic cylinders connected to a small capacity hydro-pneumatic accumulator situated in the base unit assembly by means of hydraulic pressure pipelines passing through a 3-position hydraulic valve and plurality of check valves, and the said two pairs of multi stage telescopic hydraulic cylinders projecting upwards and outwards of the base unit assembly and each pair of multi stage telescopic hydraulic cylinders carrying the half platform and combined platform of the stepladder when both the half platforms at the same level functioning as a wide area combined platform for the user to comfortably stand and carry out any task at a higher level from the floor.

In an embodiment, the base unit assembly including a mini, rechargeable battery operated air pump in conjunction with an electric panel having a compressed air pressure display and a plurality of control switches to operate the air pump which in turn connected by means of an air pipeline to an air chamber of the hydro-pneumatic accumulator and thereby to regulate the pressure of compressed air in the air chamber of the hydro-pneumatic accumulator.

In an embodiment, the base plate of the base unit assembly having four supporting legs with an anti-skid footing for resting on the floor while the stepladder used for climbing and working by standing on the combined platform, wherein the base plate includes four spring loaded retractable swivel caster wheel assemblies built inside the supporting legs for raising and supporting weight of the stepladder for easily moving around on the floor.

In an embodiment, a pre-step built inside the base unit assembly for the user to conveniently get on the platform of the stepladder in its lowest position while starting to climb the stepladder, after the user rolls the stepladder and sets it at the required location for climbing, the user first pulls out into position the pre-step provided using his or her leg, during this action of the user a combination of lever and roller arrangement provided inside the base assembly automatically gets operated retracting the retractable swivel caster wheel assemblies and thus resting the stepladder on the four supporting legs directly and firmly on the floor with no lateral movement possible for the step ladder while the user is climbing and working on the step ladder; wherein after the completion of the use of the stepladder, the user pushes the pre-step back to its original position inside the base assembly by use of his or her foot and this in turn automatically bring the retractable swivel caster wheel assemblies to its initial position allowing the stepladder to be comfortably rolled and be moved on the floor.

In an embodiment, a sliding valve arrangement consisting of a sliding valve incorporated inside a seal assembly which forms a bottom part of each stage of the multi stage hydraulic telescopic cylinder for ensuring strictly progressive extension and retraction of different stages even though the multi stage telescopic hydraulic cylinders are of small size diameters and working with low pressure and low volume hydraulics, wherein the sliding valve functioning as a normal one way spring operated hydraulic check valve with override function facility kept in closed position by means of a spring and the sliding valve of a piston of a particular stage is brought into open position automatically after it has reached almost an end of its stroke allowing hydraulic fluid to enter the next stage by means of a fixed length chain arrangement connected to the sliding valve of the piston and a bottom of the particular stage cylinder, the fixed chain length being a few millimetres shorter than the maximum stroke of the piston wherein the stretched chain in effect pulls and opens the sliding valve by counteracting with spring pressure which keeps the sliding valve closed.

In an embodiment, the sealing assembly at a bottom of each piston being provided with a bucket chamber of sufficient volume for safely accommodating the chain, wherein the chain collapsed into a heap and maintain connection) when the piston of each stage is at its withdrawn bottom position in the respective stage cylinders.

In an embodiment, the 3-position hydraulic valve in a hydraulic circuit between the hydro-pneumatic accumulator and the two pairs of multi stage telescopic hydraulic cylinders, wherein a first position of the 3-Position hydraulic valve is for pressurised hydraulic fluid to flow from the hydropneumatic accumulator through a one-way check valve into each of the pair of multi stage telescopic hydraulic cylinders, wherein a second position being a standby and neutral position to cut-off the flow of the hydraulic fluid in both directions, and wherein a third position for the pressurised hydraulic fluid from the two pairs of multi stage telescopic hydraulic cylinders to return to the hydropneumatic accumulator through a route bypassing the one way check valves, wherein the third position selected when the user needs to come back to a low level starting position.

In an embodiment, a built-in system for the stepladder user to decide the height of the steps and the platform based on his or her stance and actions while standing on the platform of the stepladder.

In a preferred embodiment, the method for operating the domestic hydraulic stepladder as claimed in claim 1, comprising the following steps. Climbing steps formed by one or the other half platform of the combined platform, by the user, raising the half platform automatically to a higher level in relation to the other stationary loaded half platform by means of the multi stage hydraulic telescopic hydraulic cylinders attached to it; raising the multi stage hydraulic telescopic hydraulic cylinders up and outwards due to pressure inside the mentioned telescopic cylinders created by the pressurised hydraulic fluid being supplied to them from hydro-pneumatic accumulator through pressure oil pipeline fitted with a 3-position hydraulic valve and check valves, during the climbing; and locking into a level position by the user selecting a second (flow cut-off) position of the 3-position hydraulic valve when the two half platforms are at same level.

In an embodiment, the method includes bringing the half platforms back to a low level starting position by operating and bringing a foot lever No. 22 to its third position by the user, wherein the foot lever selecting a third position of the 3-position hydraulic valve, wherein the third position of the hydraulic valve for returning hydraulic fluid from the multi stage hydraulic telescopic cylinders to hydro-pneumatic accumulator situated in the base unit assembly No. 2 at an underside of the base plate No. 3. The potential energy under the pressure of weight of user descending from a higher level to a lower level stored in the hydro-pneumatic accumulator in form of re-compressed compressed air in the air chamber for later use, and bringing the foot lever No. 22 back to the starting position by the user, selecting cut-off/neutral position of the 3-position hydraulic valve No. 8 before getting off the platform.

In an embodiment, the method including rising one of the half platform of the combined platform acting as a step when not being loaded, locking at the level as soon as the user steps on the half platform and applies load, wherein infinitely variable height for steps and platform No. 20 resulting based on how soon or how slowly the user applies the foot load, wherein built in maximum possible step height being 4 inches, rising other half platform till it comes in level with the raised half platform and locking in place resulting in both the halves of the platform being in same level when the user transferring weight to the raised half platform and unloading the other half platform, thereby resulting in the combined wide area platform; and wherein height increments of the half platform decided by the user, and the user repeating the procedure to achieve the height of the combined platform to do the necessary task at any level in a comfortable and safe way possible.

In an embodiment, the user is at a desired high level and able to comfortably stand with both feet at same level on a broad combined platform similar to standing on a flat ground and with the feet in any direction and being in a position on the mentioned platform to carry out any task by working facing any of the 4 directions or all of 360 degrees.

1-15. (canceled)

16. A domestic hydraulic stepladder characterized by infinitely variable height for steps and platform, comprising:
a wide area combined platform of the stepladder, wherein the platform is split into two half-platforms;
wherein each of the half-platforms, when at different levels, functions as a step of the stepladder, and when at the same level, functions as the combined platform of the stepladder;
one or more pairs of multi-stage telescopic hydraulic cylinders connected to the half-platforms, wherein the multi-stage telescopic hydraulic cylinders enable the raising of an unloaded half-platform to a higher level relative to the other loaded half-platform;
a base unit assembly comprising a base plate having four legs for resting on a floor;
wherein the multi-stage telescopic hydraulic cylinders are mounted on the base unit assembly; and
wherein each half-platform is mounted on the multi-stage telescopic hydraulic cylinders.

17. The domestic hydraulic stepladder as claimed in claim 16, wherein:
each pair of multi-stage telescopic hydraulic cylinders supports a respective half-platform;
the combined platform allows each half-platform to move independently in relation to the other half-platform; and
the two half-platforms are connected to each other by a pair of sliding bearings.

18. The domestic hydraulic stepladder as claimed in claim 16, wherein:
the multi-stage telescopic hydraulic cylinders are connected to a small-capacity hydro-pneumatic accumulator situated in the base unit assembly via hydraulic pressure pipelines;
the hydraulic pipelines pass through a 3-position hydraulic valve and a plurality of check valves;
the two pairs of multi-stage telescopic hydraulic cylinders project upwards and outwards from the base unit assembly; and
each pair of multi-stage telescopic hydraulic cylinders supports a respective half-platform, wherein both half-platforms, when positioned at the same level, function as a wide-area combined platform for the user to stand comfortably and perform tasks at an elevated level.

19. The domestic hydraulic stepladder as claimed in claim 16, wherein:
the base unit assembly includes a mini, rechargeable battery-operated air pump;
the air pump is configured in conjunction with an electric panel having:
a compressed air pressure display, and
a plurality of control switches to operate the air pump;
the air pump is connected via an air pipeline to an air chamber of the hydro-pneumatic accumulator; and
the air pump regulates the pressure of compressed air in the air chamber of the hydro-pneumatic accumulator.

20. The domestic hydraulic stepladder as claimed in claim 16, wherein:
the base plate of the base unit assembly includes four supporting legs with anti-skid footings for stable placement on the floor while the stepladder is used for climbing and working on the combined platform; and
the base plate further includes four spring-loaded retractable swivel caster wheel assemblies built inside the supporting legs, wherein the swivel caster wheel assemblies enable the stepladder to be raised and moved easily on the floor.

21. The domestic hydraulic stepladder as claimed in claim 16, wherein:
a pre-step is built inside the base unit assembly to allow the user to conveniently access the platform of the stepladder in its lowest position when starting to climb;
the pre-step is pulled into position by using the user's leg, which activates a lever and roller arrangement inside the base unit assembly to:
retract the swivel caster wheel assemblies; and
rest the stepladder firmly on the four supporting legs, preventing lateral movement while the user is climbing or working on the stepladder; and
after use, the user pushes the pre-step back to its original position inside the base unit assembly using their foot, which automatically returns the swivel caster wheel assemblies to their initial position, enabling the stepladder to be rolled and moved on the floor.

22. The domestic hydraulic stepladder as claimed in claim 16, wherein:
a sliding valve arrangement is incorporated inside a seal assembly, which forms the bottom part of each stage of the multi-stage telescopic hydraulic cylinder, for ensuring strictly progressive extension and retraction of different stages, even though the multi-stage telescopic hydraulic cylinders are of small size diameters and operate with low pressure and low volume hydraulics;
the sliding valve arrangement ensures strictly progressive extension and retraction of the multi-stage telescopic hydraulic cylinders, even though the cylinders are of small diameters and operate with low-pressure and low-volume hydraulics;
the sliding valve functions as a one-way spring-operated hydraulic check valve with an override function, which is kept in a closed position by means of a spring;
the sliding valve is automatically brought into the open position after the piston of a particular stage reaches almost the end of its stroke, allowing hydraulic fluid to enter the next stage; and
a fixed-length chain arrangement connects to the sliding valve of the piston and the bottom of the particular stage cylinder, with the chain being a few millimetres shorter than the maximum stroke of the piston, such that the stretched chain pulls and opens the sliding valve by counteracting the spring pressure that keeps the valve closed.

23. The domestic hydraulic stepladder as claimed in claim 18, wherein:
the sealing assembly at the bottom of each piston includes a bucket chamber of sufficient volume to safely accommodate the valve-operating chain;
the chain collapses into a heap and maintains its connection to the piston when the piston reaches the bottom of its stroke in the respective stage cylinders.

24. The domestic hydraulic stepladder as claimed in claim 16, wherein:
the 3-position hydraulic valve is positioned in a hydraulic circuit between the hydro-pneumatic accumulator and the two pairs of multi-stage telescopic hydraulic cylinders;
in a first position, the 3-position hydraulic valve permits the flow of pressurized hydraulic fluid from the hydro-pneumatic accumulator to each pair of the multi-stage telescopic hydraulic cylinders through a one-way check valve;
in a second position, the 3-position hydraulic valve acts as a neutral position, cutting off the flow of hydraulic fluid in both directions; and
in a third position, the 3-position hydraulic valve allows pressurized hydraulic fluid from the multi-stage telescopic hydraulic cylinders to return to the hydro-pneumatic accumulator, bypassing the one-way check valves, which is selected when the user needs to lower the stepladder back to a low-level starting position.

25. The domestic hydraulic stepladder as claimed in claim 16, wherein a built-in system allows the user to adjust the height of the steps and platform based on their stance and actions while standing on the platform of the stepladder.

26. A method for operating the domestic hydraulic stepladder as claimed in claim 16, comprising the steps of:
climbing steps formed by either half-platform of the combined platform;
automatically raising one half-platform to a higher level in relation to the other stationary half-platform, using multi-stage telescopic hydraulic cylinders connected to the half-platform;
pressurizing the multi-stage telescopic hydraulic cylinders by hydraulic fluid supplied from the hydro-pneumatic accumulator through a hydraulic pressure pipeline fitted with a 3-position hydraulic valve and check valves, enabling the raising of the half-platforms during the climbing process; and
locking the half-platforms into a level position by selecting the second position of the 3-position hydraulic valve, which cuts off the hydraulic fluid flow, when both half-platforms are at the same level.

27. The method for operating the domestic hydraulic stepladder as claimed in claim 26, wherein:
the user brings the half-platforms back to a low-level starting position by operating a foot lever, which selects the third position of the 3-position hydraulic valve;
the third position of the hydraulic valve allows hydraulic fluid to return from the multi-stage telescopic hydraulic cylinders to the hydro-pneumatic accumulator situated in the base unit assembly.

28. The method for operating the domestic hydraulic stepladder as claimed in claim 27, wherein:
potential energy created by the weight of the user descending from a higher level to a lower level is stored in the hydro-pneumatic accumulator as re-compressed air in the air chamber for later use; and
the user brings the foot lever back to its starting position, selecting the cut-off/neutral position of the 3-position hydraulic valve before getting off the platform.

29. A method for operating the domestic hydraulic stepladder as claimed in claim 16, comprising the steps of:
raising one of the half-platforms of the combined platform, which serves as a step when not under load;
locking the raised half-platform at the desired level as soon as the user steps on it and applies weight;
adjusting the height of the steps and platform infinitely, based on how quickly or slowly the user applies weight, when the user is transferring the weight to the raised half-platform and unloading the other half-platform, with a maximum step height increment of 4 inches;
raising the other half-platform until it aligns with the raised half-platform and locking it into place, thereby forming a combined wide-area platform; and
allowing the user to control the height increments of the half-platforms and repeating the process to achieve the desired height of the combined platform for performing tasks comfortably and safely.

30. The method for operating the domestic hydraulic stepladder as claimed in claim 26, wherein:
the user reaches a desired height and is able to comfortably stand with both feet at the same level on a broad combined platform, similar to standing on flat ground;
the user positions their feet in any direction on the platform; and
the user is able to perform tasks while facing any of the four directions or across 360 degrees of the platform.
